(19) United States
(12) Patent Application Publication
(10) Pub. No.: US 2011/0291826 A1
(43) Pub. Date: Dec. 1, 2011

(54) METHOD FOR ASSIGNING TIRE PRESSURE SENSORS OF A TIRE PRESSURE MONITORING SYSTEM TO WHEEL POSITIONS

(75) Inventors: Christoph FERBER, Alsheim (DE); Alexander WEBER, Gross-Gerau (DE)

(73) Assignee: GM GLOBAL TECHNOLOGY OPERATIONS LLC, Detroit, MI (US)

(21) Appl. No.: 13/116,107

(22) Filed: May 26, 2011

(30) Foreign Application Priority Data
May 26, 2010 (DE) 102010021570.8

(51) Int. Cl. B60C 23/02

(52) U.S. Cl. 340/442

(57) ABSTRACT

A method is provided for the assignment of tire pressure sensors of a tire pressure monitoring system to wheel positions on a vehicle. In each case a tire pressure sensor of a tire pressure checking device is assigned to a wheel. The method includes, but is not limited to measurement of a centrifugal force on a number of wheels by means of a centrifugal force sensor assigned to the tire pressure checking device at a time t; determination of the wheel rotational speed of a number of wheels at the time t. The assignment of the values for the wheel rotational speed to the wheel position is known. The method further includes, but is not limited to correlation of the measured centrifugal forces with the determined wheel rotational speeds for the assignment of the tire pressure sensors to the wheel positions.

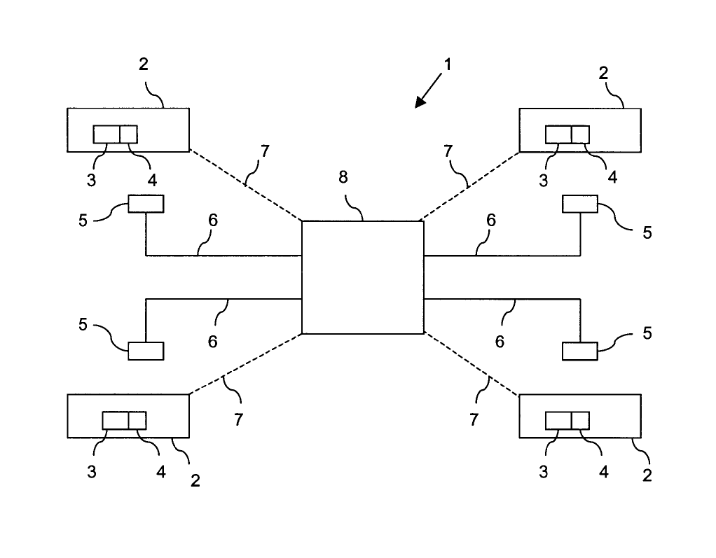

### CROSS-REFERENCE TO RELATED APPLICATION

This application claims priority to German Patent Application No. 102010021570.8, filed May 26, 2010, which is incorporated herein by reference in its entirety.

### TECHNICAL FIELD

The technical field relates to a method for assigning tire pressure sensors of a tire pressure monitoring system to wheel positions of a vehicle.

### BACKGROUND

Since tires of a vehicle are changed at times to guarantee an always reliable and thus preferably automatic assignment of tire pressure sensors integrated in the tires to the respective wheel position. From DE 199 21 413 C1 such a method is known, wherein a high-frequency signal with a defined time period, which at least is as long as the time required for a wheel revolution, is emitted by a sender integrated in a tire pressure checking device. Here, an individual curve dependent on the angle of rotation of the wheel is imposed on the high-frequency signal. From this curve, the number of the revolutions made in a time interval is determined and compared with direct measurements of the wheel rotational speeds. Since the wheel rotational speed sensors are mounted location ally fixed for example on the wheel house their assignment to the wheel position is known. In addition, methods are known wherein on the vehicle in the region of the wheel houses for each tire a receiver is provided, which receives signals emitted by the tire pressure checking device. However, this is very involved.

Therefore, at least one object is to provide a method which allows an assignment of tire pressure sensors of a tire pressure monitoring system to wheel positions of a vehicle in a manner that is technically simple and saves energy on the wheel and which is highly reliable at the same time. In addition, other objects, desirable features and characteristics will become apparent from the subsequent summary and detailed description, and the appended claims, taken in conjunction with the accompanying drawings and this background.

### SUMMARY

A method is provided for the assignment of tire pressure sensors of a tire pressure monitoring system to wheel positions on a vehicle, wherein in each case a tire pressure sensor of a tire pressure checking device is assigned to a wheel. The method comprises the following steps: measurement of a centrifugal force on a number of wheels by means of the centrifugal force sensor assigned to the tire pressure checking device at a time t; determination of the wheel rotational speed of a number of wheels at the time t, wherein the assignment of the values for the wheel rotational speed to the wheel position is known; and correlation of the measured centrifugal forces with the determined wheel rotational speeds for assigning the tire pressure sensors to the wheel positions.

In an embodiment the measurement of the centrifugal force is carried out on a number of wheels multiple times at a time interval t-t₁ and the measurements are averaged via the time interval t₂-t₁ and correlated with a wheel rotational speed determined for the time interval t₂-t₁.

The centrifugal force sensor which is often installed on the tire pressure checking device anyway can be utilized for assigning the tire pressure sensors to the wheel position. The centrifugal force measured on the tire has a dependency on the wheel rotational speed. This can be utilized when the measurements of the centrifugal force sensors are combined with the rotational wheel speeds determined by means of the rotational speed sensors, whose assignment to the wheel position is known because of the arrangement of the rotational speed sensors in the region of the wheel house.

The measurement of the centrifugal force is repeated frequently so that a statistical evaluation and a correlation with the wheel rotational speed are possible. Here, for example the mean value of the centrifugal force in the time interval t₂-t₁ and the mean value of the wheel rotational speed in the same time interval t₂-t₁ are correlated. Possible rotational speed sensors are both passive and active sensors which utilize the Hall effect.

The length of the time interval t₂-t₁ can be more or less than the time required for a wheel revolution. It can also be several wheel revolutions long. In particular, it can be taken into account when selecting the length of the time interval that the reliability of the assignment of the tire pressure checking device to a wheel position has priority over its speed. The reliability of the assignment increases with a better statistic. Since the speed of the assignment is only of subordinate importance an assignment requiring several seconds can also be accepted.

In an embodiment the length of the time interval t₂-t₁ is dependent on a current speed of the vehicle. Thus, the quality of the available measurements, particularly of the centrifugal forces and its errors, can be taken into account when selecting the time interval. The measurements of the centrifugal force sensors according to an embodiment are sent by the tire pressure checking device to a central control unit. Alternatively or additionally the measurements of the centrifugal force sensors averaged via the time interval t₂-t₁ can also be sent by the tire pressure checking device to a central control unit. In an embodiment, the method is started by starting the vehicle. It can subsequently be carried out via a number of time intervals t₂-t₁ or at a number of times t until an adequate reliability is reached. Following this, it can be repeated at certain time intervals and/or following the next starting of the vehicle and/or upon the request of the driver. In an alternative embodiment the method is started when a movement of the vehicle is detected. The movement of the vehicle can be particularly detected in that the centrifugal force sensors supply values differing from zero.

The method has the advantage that it makes possible in a particularly simple manner an automatic assignment of the tire pressure checking devices to the wheel positions with reliable components that are mostly present anyway. Furthermore it is advantageous that because of the statistical method merely a relative measurement of the respective centrifugal forces is necessary. It is not necessary to know the exact relationship between centrifugal force and rotational speed. It is more preferably not absolutely necessary to take into account parameters such as the wheel diameter since the assignment takes place by means of individual fluctuations and variations in the centrifugal forces which can be attributed to corresponding fluctuations and variations of the wheel rotational speeds.

According to an embodiment, a computer program product is provided to carry out the described method when the computer program is executed on a computer unit or a control unit.

### BRIEF DESCRIPTION OF THE DRAWINGS

The present invention will hereinafter be described in conjunction with the following drawing figure showing a block diagram of a tire pressure monitoring system for carrying out the method according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

The tire pressure monitoring system 1 comprises four tire pressure checking devices 2 which in known manner each comprise a tire pressure sensor 3 which for example can be attached inside on the valve of the tire. The tire pressure checking devices 2 furthermore comprise a centrifugal force sensor 4 each. The tire pressure sensors 3 and the centrifugal force sensors 4 are thus connected to the wheel itself and are likewise removed from the vehicle in the case of a wheel change. The tire pressure monitoring system 1 additionally comprises a wheel rotational speed counter 5 per wheel, which in contrast with the tire pressure sensors 3 and the centrifugal force sensors 4 is not arranged on the wheel, but location ally fixed on the vehicle. The tire pressure checking devices 2 are connected to a control unit 8 of the vehicle via a wireless data connection 7. The wheel rotational speed counters 5 are connected to the control unit 8 by means of cable-based data connections 6.

In operation, the centrifugal force sensors 4 on starting of the vehicle, i.e., when actuating the ignition, commence measuring the centrifugal forces prevailing on the respective wheel. By way of a time interval t₂-t₁ a mean value of the centrifugal force is determined in each case and sent to the control unit 8. The control unit furthermore receives measurements of the wheel rotational speed counters 5 from the same time interval t₂-t₁ and assigns the mean values of the centrifugal force to the wheel rotational speed measurements by means of the correlation strengths. The time interval t₂-t₁ is selected long enough for an adequate reliability of the assignment.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for assigning tire pressure sensors of a tire pressure monitoring system to wheel positions on a vehicle, a tire pressure sensor is assigned to a tire pressure checking device on a wheel and the method comprising:
measuring a centrifugal force on a number of wheels with a centrifugal force sensor assigned to the tire pressure checking device at a time t;
determining the wheel rotational speed of the number of wheels at the time t, wherein an assignment of the values for the wheel rotational speed to the wheel position is known; and
correlating centrifugal forces with the wheel rotational speeds for the assignment of the tire pressure sensors to the wheel positions.

2. The method according to claim 1, wherein measuring the centrifugal force is carried out on the number of wheels at several times at a time interval t₂-t₁ and the method further comprises:
averaging via the time interval t₂-t₁; and
correlating with a wheel rotational speed determined for the time interval t₂-t₁.

3. The method according to claim 2, wherein a length of the time interval t₂-t₁ corresponds to less than a wheel revolution time.

4. The method according to claim 2, wherein a length of the time interval t₂-t₁ corresponds to at least a wheel revolution time.

5. The method according to claim 2, wherein a length of the time intervals t₂-t₁ is dependent on a current speed of the vehicle.

6. The method according to claim 1, further comprising sending the measurements of the centrifugal force sensor by the tire pressure checking device to a central control unit.

7. The method according to claim 2, further comprising:
averaging the measurements of the centrifugal force sensor via the time interval; t₂-t₁ and
sending the tire pressure checking device to a central control unit.

8. The method according to claim 1, further comprising initiating the method with a starting of the vehicle.

9. The method according to claim 1, further comprising initiating the method with a detection of a movement of the vehicle.

10. A computer readable medium embodying a computer program product, said computer program product comprising:
a program for assigning tire pressure sensors of a tire pressure monitoring system to wheel positions on a vehicle, a tire pressure sensor is assigned to a tire pressure checking device on a wheel, the program configured to:
measure a centrifugal force on a number of wheels with a centrifugal force sensor assigned to the tire pressure checking device at a time t;
determine the wheel rotational speed of the number of wheels at the time t, wherein an assignment of the values for the wheel rotational speed to the wheel position is known; and
correlate centrifugal forces with the wheel rotational speeds for the assignment of the tire pressure sensors to the wheel positions.

11. The computer readable medium embodying the computer program product according to claim 10, wherein measurement of the centrifugal force is carried out on the number of wheels at several times at a time interval t₂-t₁ and the program is further configured to:
averaging via the time interval t₂-t₁; and
correlating with a wheel rotational speed determined for the time interval t₂-t₁.

12. The computer readable medium embodying the computer program product according to claim 11, wherein a length of the time interval t₂-t₁ corresponds to less than a wheel revolution time.

13. The computer readable medium embodying the computer program product according to claim 11, wherein a length of the time interval t₂-t₁ corresponds to at least a wheel revolution time.

14. The computer readable medium embodying the computer program product according to claim 11, wherein a length of the time intervals t₂-t₁ is dependent on a current speed of the vehicle.

15. The computer readable medium embodying the computer program product according to claim 11, wherein the program is further configured to send the measurements of the centrifugal force sensor by the tire pressure checking device to a central control unit.

16. The computer readable medium embodying the computer program product according to according to claim 11, the program further configured to:
average the measurements of the centrifugal force sensor via the time interval; t₂-t₁ and send the tire pressure checking device to a central control unit.

17. The computer readable medium embodying the computer program product according to according to claim 10, the program further configured to initiate with a starting of the vehicle.

18. The computer readable medium embodying the computer program product according to claim 10, the program further configured to initiate with a detection of a movement of the vehicle.
